(19) United States
(12) Patent Application Publication
(10) Pub. No.: US 2013/0266669 A1
(43) Pub. Date: Oct. 10, 2013

(54) METHODS OF REMOVING MICROBES FROM SURFACES

(71) Applicants: Juan Jiang, Shanghai (CN); Jeffrey Melzer, Lansdale, PA (US); Wilson Kurt Whitekettle, Jamison, PA (US); Guixi Zhang, Shanghai (CN); Qing Zhao, Kalmar (SE)

(72) Inventors: Juan Jiang, Shanghai (CN); Jeffrey Melzer, Lansdale, PA (US); Wilson Kurt Whitekettle, Jamison, PA (US); Guixi Zhang, Shanghai (CN); Qing Zhao, Kalmar (SE)

(21) Appl. No.: 13/266,570

(22) PCT Filed: Dec. 22, 2010
(86) PCT No.: PCT/CN10/02122

§ 371 Date: Oct. 27, 2011

(51) Int. Cl. A01N 65/00

(52) U.S. Cl. CPC A01N 65/00
USPC 424/725

(57) ABSTRACT

A method has been found for the inhibition of microbial biofilm on surfaces in contact with systems, such as aqueous systems. In accordance with the method, an effective amount of a modified tannin biofilm control agent is fed to the system water. The modified tannin biofilm control agent comprises a reaction product of an amine, an aldehyde and tannin and provides a good environmental profile.

### FIELD OF INVENTION

The field of the invention relates to methods for inhibiting microbial biofilm on surfaces in contact with systems, including but not limited to aqueous systems. More particularly, the invention relates to the use of an environmentally friendly modified tannin biofilm control agent for inhibiting microbial biofilm.

### BACKGROUND OF THE INVENTION

Industrial process- or operating-water systems, such as, open or closed water-cycle systems, in particular cooling-water systems, offer suitable conditions for the growth of microorganisms, with the result that a slime known as biofilm is formed on the surfaces of water-bearing systems. In the case of cooling water systems in particular, these biofilm deposits can lead to reduced heat exchange efficiency, pipeline damage and corrosion within the systems. Adverse effects on process control are possible, which can ultimately reduce the efficiency of the industrial process in question and impair product quality. In addition to this, biofilm or slime deposits generally lead to higher energy consumption.

The deposition of the bacterial slimes can most effectively be controlled with biocides, the effect of these biocides being based on the fact that they kill off the microorganisms in the operating water and thus prevent slime production. However, biocide concentrations needed to control biofilm are much higher than those needed to control planktonic bacteria. Thus, biocides to control biofilm increase costs, and raise doubts on ecological grounds. Also, because of their toxicity, biocides pose considerable dangers when handled. For this reason, alternative ways of eliminating biofilm are needed.

Industrial efforts to prevent colonization or to clean fouled surfaces amount to costly expenditures in many industries. Often, such expenditures are made for cleaning programs that include the use of surfactants. Surfactants are regularly applied in water treatment programs as agents believed to play a role in the removal of organic masses from surfaces, in the enhancement of biocide efficacy or in the assistance in the water miscibility of various biocidal agents. The more non-toxic surfactants often require higher levels of concentrations to achieve their purpose, thereby making them uneconomical due to the huge amount of water treated, and prone to forming high levels of unwanted foam. Also, surfactants are toxic to non-target aquatic organisms upon discharge to common receiving bodies of water.

Beyond the higher levels of concentration, another issue of most non-toxic surfactants is foaming which results in the need to feed antifoam compositions to the system. Foam, even with feeding antifoam compositions, are not preferred in some industrial application like air separation process. In fact, U.S. Pat. Nos. 6,054,054 and 5,128,100 refer to water-soluble polymers such as polydiallyldimethylammonium chloride (PDADMAC) and ionene polymer, which reputedly do not foam when fed to the system for microbial control function.

Additionally, in many aqueous systems, such as in industrial cooling systems, scale control agents (SCA) are added to the system water to inhibit or control scale formation that would otherwise form. Such scale forming precipitates include calcium, magnesium, and iron or copper salts and complexes. In many cases in which biofilm control agents are also added to these systems, the bio film control agent impairs the ability of the SCA to remain dissolved or suspended in the water system. Undesirable precipitation of the SCA means that less of the SCA is available in the system water to perform its intended scale control function.

### SUMMARY OF THE INVENTION

A method is provided for inhibiting microbial biofilm on surfaces in contact with aqueous systems. In one exemplary embodiment, the method comprises adding an effective amount of a modified tannin to the aqueous system while presenting little (minimal) danger to non-targeted aquatic organisms at discharge due to its biodegradable feature and environmentally friendly profile. Economical advantages because of low dosage feed rates are also present. Additionally, in one aspect of the invention, the modified tannin herein is nonfoaming, presenting another benefit for aqueous system application. The modified tannin biofilm control agent in this invention is a Mannich reaction product of an amine, and aldehyde, and a tannin. In another aspect of the invention, the amine component of the reaction product is a primary amine, and the aqueous system may, for example, be a cooling water system. The modified tannin may be fed to the cooling water system in an amount of about 1 ppm to about 400 ppm, with an alternative range of from about 5 to about 200 ppm, and a further embodiment of about 10 to about 100 ppm. It is noted that any range or ranges disclosed in this specification are deemed to include and provide support for sub-ranges within the stated range or ranges. Any range or ranges disclosed in this description are deemed to include and provide support for any point or points within that range or ranges.

In another aspect of the invention, a scale control agent is present in the aqueous system, and an improved method comprises adding to the scale control agent containing aqueous system the modified tannin control agent to inhibit biofilm from surfaces in the aqueous system. Thus, the modified tannin has demonstrated good compatibility with scale control agent in the system. The modified tannin biofilm control agent comprises a reaction product of an amine, an aldehyde, and a tannin. In another exemplary embodiment, the aqueous system is a cooling water system, and the scale control agent added to the system is an anionic polymer scale control agent such as, for example, an acrylic acid homopolymer, copolymer or terpolymer. The term copolymer shall be construed herein as containing either two or more monomeric repeat units.

The various features of novelty that characterize the invention are pointed out with particularity in the claims annexed to and forming a part of this disclosure. Changes to and substitutions of the components of the invention can of course be made. The invention resides as well in sub-combinations and sub-systems of the elements described, and in methods of using them.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about,” are not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including.” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

In one embodiment of the present invention, the modified tannin biofilm control agent removes or reduces microbial slime from surfaces in contact with aqueous systems better than that caused by water alone. As used throughout the specification and claims, the words inhibit and/or inhibition are intended to refer both to the function of removing biofilm from structural surfaces in contact with system waters and to the retardation or growth diminishment of the biofilms.

An embodiment of the present invention provides a method for inhibiting the growth of microbial biofilm on surfaces in contact with systems, including, but not limited to aqueous systems such as cooling water systems such as open recirculating, closed recirculating and once through cooling systems, pulping and papermaking systems, water transport pipelines, reverse osmosis systems, air washer systems, shower water systems, hydrocarbon storage systems, hydrocarbon transport pipelines, aqueous metal working systems and aqueous mineral processing systems.

In one aspect of the invention, the biofilm control agent in accordance with the invention is a Mannich reaction product of an amine, an aldehyde, and a tannin, as set forth in U.S. Pat. No. 4,558,080, incorporated by reference herein in its entirety. As is stated in this patent, the amine, aldehyde, and tannin can be combined simultaneously, or in different orders. The components are reacted at an acidic pH wherein the molar ratio of amine, such as one having primary amine functionality, to tannin present is from about 1.5:1-3.0:1. Exemplary tannin/amine/formaldehyde compounds include tannin/melamine/formaldehyde polymers, and tannin/monoethanolamine/formaldehyde polymers. Compounds according to the present convention are being sold by GE under the designation Klaraid PC 2700.

The modified tannin agent in this claim has an environmentally friendly profile, namely, it has minimal toxicity to mammalian as well as aqueous organisms and it's biodegradable so that it results in minimal harmful effect to the environment after discharge.

The modified tannin as a product Mannich reaction of a tannin, an amine, and an aldehyde, does not significantly foam in application, therefore, in accordance with one aspect of the invention, none or substantially no antifoaming agents are needed.

The tannin component can be obtained from the various wood and vegetation materials found throughout the world. Tannins are a large group of water-soluble, complex organic compounds. Almost every tree or shrub that grows contains some tannins in the leaves, twigs, barks, wood or fruit. Examples of barks are wattle, mangrove, oak, eucalyptus, hemlock, pine, larch and willow. Examples of woods are the quebracho, chestnut, oak and urunday. Examples of fruits are myrobalans, valonia, divi-divi, tara, and algarrobilla. Examples of leaves are sumac and gambier and examples of roots are canaigre and palmetto. Among the preferred materials are the quebracho wood. A spray-dried quebracho powder is sold by Canada Packers, Ltd. as Mimosa Extract.

These natural tannins can be categorized into the traditional “hydrolyzable” tannins and “condensed tannins” as disclosed by A. Pizzi in “Condensed Tannins for Adhesives”, Ind. Eng. Chem. Prod. Res. Dev. 1982, 21, 359-369. Condensed tannin extracts are those manufactured from the bark of the black wattle tree (or mimosa tannin of commerce), from the wood of the quebracho tree (Spanish: quebra hacha, axe-breaker,) from the bark of the hemlock tree, and from the bark of several commonly used pine species. The preparation of wattle and quebracho extracts is a well established industrial practice and they are freely available in considerable amounts.

Condensed tannin extracts, such as wattle and quebracho, are composed of approximately 70% polyphenolic tannins, 20% to 25% nontannins, mainly simple sugars and polymeric carbohydrates (hydrocolloid gums), the latter of which constitute 3% to 6% of the extract and heavily contribute to extract viscosity, while the balance is accounted for by a low percentage of moisture. Although the exact structure is not known, it is believed that the main polyphenolic pattern in quebracho tannins is represented by flavonoid analogues based on resorcinol A and pyrogallol B rings as shown in Formula I below:

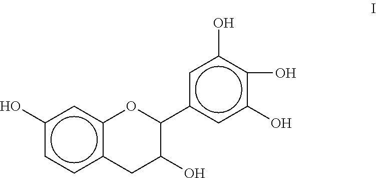

The second component is an aldehyde. Examples of preferred materials are formaldehyde which can be used in the form of a 37% active formaldehyde solution. This is also commercially available as formalin which is an aqueous solution of 37% formaldehyde which has been stabilized with from 6-15% methanol. Other commercial grades of formaldehyde and its polymers could be used. Such commercial grades include 44, 45 and 50% low-methanol formaldehyde, solutions of formaldehyde in methyl, propyl, n-butyl, and isobutyl alcohol, paraformaldehyde and trioxane. When using solid paraformaldehyde, care must be taken to ensure that it dissolves.

Other aldehyde containing or generating reactants are organic chemical compounds which contain at least one aldehyde group therein as are well known and include, for example, formaldehyde, acetaldehyde, propionaldehyde, glycolaldehyde, glyoxylic acid and the like or polyaldehydes i.e., organic compounds having more than one aldehyde group in the compound, such as glyoxal, paraformaldehyde and the like. Other suitable aldehyde reactants include aldehyde generating agents i.e., known organic compounds capable of forming an aldehyde group in situ, such as melamine-formaldehyde monomeric products and derivatives such as tri and hexa(methylol) melamine and the tri and hexa (C₁-C₃ alkoxymethyl)melamine. Such materials can be formed by known conventional methods. The alkyl blocked derivatives are commercially available, are stable to self polymerization and are, therefore, preferred.

The third component for the reaction product is an amino compound such as ammonia or a primary or secondary amine or amide compound. Preferred materials include primary amines such as monoethanolamine, methylamine and ethylamine. The primary amines are preferred since they are more reactive than secondary or tertiary amines. Also, heterocyclic amines having mixed primary and secondary amine functionality such as melamine may be mentioned.

In reacting these three components it is necessary to do this under very controlled conditions and especially under a slight acidic condition where the pH is less than 7. Any acid can be used to obtain this condition and especially preferred are muriatic acid and acetic acid.

The product obtained is believed to consist of a polymeric substance which has been modified by a “Mannich” reaction. In the Mannich reaction an aldehyde is condensed with an amino compound and an active hydrogen supplied by the polyphenolic tannin Although the structure of tannin is not completely known, it is believed the reaction product can be approximated by the following recurring structure:

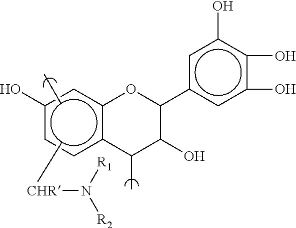

where CHR′ is the remainder of the aldehyde compound after the carbonyl oxygen has left and R¹ and R² are hydrogen or other organic moieties that were part of the original amino compound.

According to this model the molecular weight of a repeating tannin unit is assumed to be approximately 300. The preferred molar ratio of the primary amine to the tannin repeating unit is in the range of about 1.5:1 to 3.0:1.

In one exemplary embodiment, from about 1 ppm to about 400 ppm (or any range within this range) of the modified tannin biofilm control agent is added to the aqueous system. The aqueous system may preferably have a pH from about 3.5 to about 10.5 and may include, as stated above, varying amounts of the modified tannin such as a range from about 5 ppm to about 200 ppm or about 10-100 ppm, or about 15-50 ppm.

In another aspect of the invention, the modified tannin-based biofilm control agent is utilized in aqueous systems, such as cooling water systems, conjointly with a scale control agent, such as an anionic polymeric scale control agent. In such systems, it has been found that utilization of the modified tannin control agent is compatible with such scale control agents in that it tends to keep copious quantities of the scale control agent suspended or in solution in the system water so that the scale control agent can perform its intended scale control function. More specifically, in other exemplary embodiments, the anionic polymeric scale control agent may be present in an amount of 0.1 to 500 ppm, or any range within this range, such as about 1.0-50 ppm.

Exemplary anionic scale control agents include acrylamido sulfonic acid polymers and copolymers such as 2-acrylamido-2-methyl propane sulfonic acid (AMPS) and acrylic acid/AMPS copolymers, acrylic acid homopolymers and copolymers, and anionic salts thereof, maleic anhydride homopolymers and copolymers such as sulfonated styrene maleic anhydride copolymers, acrylamide polymers and copolymers, vinyl pyrrolidone, vinyl amide polymers, maleic acid homopolymers and copolymers, itaconic acid homopolymers and copolymers, vinyl sulfonic acid polymers, styrene sulfonic acid polymers, vinyl phosphonic polymers, etc.

In another exemplary embodiment of the invention, the anionic polymeric scale control agent may comprise an acrylic acid homopolymer or copolymer with specific mention being made of acrylic acid/2-hydroxypropylacrylate copolymers, acrylic acid/allylhydroxypropylsulfonate ether copolymers, and acrylic acid/polyethyleneglycol monoallyl ether sulfate/1-allyloxy-2-hydroxypropylsulfonic acid terpolymer.

### EXAMPLES

### Example 1

In order to demonstrate the efficacy of the tannin reaction products in inhibiting the growth of biofilms, microplate assay tests were undertaken on pseudomonas aeruginosa bacteria. The pseudomonas aeruginosa biofilms were grown in 96 well plates overnight and treated with the candidate treatments in 5 ppm, 10 ppm, 15 ppm and 30 ppm (actives) treatment amounts. Results are shown in Tables 1.1 and 1.2.

TABLE 1.1
Pseudomonas Aeruginosa Biofilm Removal

| Treatment | 5 ppm | 10 ppm | 15 ppm | 30 ppm |
|---|---|---|---|---|
| C-1 | 37.04% | 32.89% | 25.05% | 40.39% |
| C-2 | 34.56% | 38.25% | 50.13% | 52.68% |
| C-3 | 0.00% | 31.56% | 58.21% | 76.60% |
| Ex-A1 | 12.70% | 45.15% | 62.71% | 72.11% |
| C-4 | 28.39% | 39.15% | 70.32% | 86.51% |

C-1 = (ethylene oxide (EO)/propylene oxide (PO)) polymer
C-2 = trimethyl hexanoic acid modified EO/PO polymer
C-3 = polyethyleneimine
Ex-A1 = ethanolamine/formaldehyde/tannin Mannich reaction product
C-4 = AETAC/tannin copolymer having cationic charge density of 57.5% by weight; Mw ≈ 50,000-70,000 Daltons. AETAC is acryloxyethyl trimethylammonium chloride

TABLE 1.2
Pseudomonas Aeruginosa

| Treatment | |
|---|---|
| (15 ppm active) | Bio film Removal % |
| C-5 | 51% |
| C-4 | 85% |
| C-6 | 92% |
| Ex-A1 | 76% |
| C-7 | 67% |
| C-3 | 76% |

C-5 = acrylamide/DADMAC copolymer - DADMAC is diallyldimethylammonium chloride
C-6 = tannin/AETAC; cationic charge density approximately 70%
C-7 = cationic starch

### Example 2

Compatibility tests were undertaken to assess the compatibility of candidate biofilm control agents with a well-known anionic scale control agent (SCA) in a simulated cooling water system. Compatibility was reviewed from the viewpoint of the treatment's ability to maintain the SCA performance in solution without substantial precipitation of the SCA. The SCA was a well-known acrylic acid anionic copolymer SCA, namely acrylic acid/allylhydroxypropyl sulfonate ether copolymer. (See U.S. Pat. No. 4,895,663, which disclosure is incorporated by reference herein in its entirety). In this Example, the test water shown in Table 2.1 was maintained at 70° C. After 18 hours, the water was filtered by 0.22 micron membrane and the residual phosphate in the filtrate was measured. Accordingly the PO₄ deposition inhibition rate was calculated.

TABLE 2.1
Test water composition

| | |
|---|---|
| PH | 8.2 |
| Calcium (ppm as CaCO₃) | 400 |
| Magnesium (ppm as CaCO₃) | 100 |
| NaHCO₃ (ppm as CaCO₃) | 35 |
| Phosphate (ppm as PO₄) | 8 |
| SCA active(ppm) | 15 |
| Temperature | 70° C. |

A series of cationic polymers were added to above water at different dosages. The final PO₄ inhibition rate was tested respectively and listed in Table 2.2

TABLE 2.2
PO Inhibition Rate

| | 0 ppm | 7.5 ppm | 15 ppm |
|---|---|---|---|
| Ex-A1 | 91.5% | 70.8% | 69.0% |
| C8 | 91.5% | 8.3% | 14.2% |
| C4 | 91.5% | 11.9% | 21.4% |
| C7 | 91.5% | 17.3% | 7.1% |

Ex-A1, C4, and C7 are as described above.
C-8 = PDADMAC

As is evident from the data, said modified tannin as a reaction product of ethanolamine/formaldehyde/tannin is highly compatible with anionic polymer SCA.

The results show that comparative treatments, such as C-8 (PDADMAC), deleteriously interfere with the scale inhibition performance of the SCA. In sharp contrast, when the combination of 15 ppm SCA/15 ppm A-1 was used in the system waters, the scale control efficacy was at least 75% of that with the use of the SCA agent by itself at 15 ppm.

In one aspect, the modified tannin treatment agents are non-foaming and have a good environmental profile. Thus, in contrast to the use of other biofilm inhibiting agents, an antifoaming agent (otherwise referred to as “antifoam”) need not be fed to the system waters, or be fed in small quantities. Typical antifoam feed rates can be up to 50 ppm, or any range within this range, such as about 10-50 ppm, or about 2-10 ppm. Antifoams are well known in the art and may include fatty esters, acids, glycols, amides, etc. Some commercially available antifoams include Accepta 2592, 4552, 4452, and 2315 as well as Tramfloc 1170 WWT, 1171 WWT, 1172 WWT, 1173 WWT, 1174 WWT, 1175 WWT, 1176 WWT, 1177 WWT, 1178 WWT, 1179 WWT, and 1180 WWT.

Moreover, the modified tannin treatment agent, as identified by Example A-1 in the Examples, has a comparatively friendly environmental impact as shown by the following:

ENVIRONMENTAL DATA

EX-A1

Toxicological Information

| | |
|---|---|
| Oral LD50 Rat: | >5000 mg/kg |

Aquatic toxicology

| | |
|---|---|
| Daphnia magna 48 hr | LC50 = 73 mg/L |
| Fathead Minnow 96 hr LC50 | LC50 = 80 mg/L |
| Rainbow Trout 96 hr LC50 | LC50 = 14 mg/L |

Biodegradable

| | |
|---|---|
| BOD-28(mg/g) | 275 |
| BOD-5(mg/g) | 85 |
| COD (mg/g) | 480 |

In another aspect of the invention, since the modified tannin biofilm control agents serve as environmentally friendly biodispersants to substantially remove microbial biofilm on surfaces with aqueous systems, the additional level of biocides fed to the system can be reduced, forming an overall less objectionable discharge as system effluent.

While we have shown and described herein certain embodiments of the invention, it is intended that these be covered as well any change or modification therein which may be made without departing from the spirit and scope of the invention as defined in the appended claims.

What is claimed is:

1. A method for inhibiting microbial biofilm on surfaces in contact with an aqueous system which comprises adding an effective amount of a modified tannin biofilm control agent to said aqueous system, said modified tannin biofilm control agent being a Mannich reaction product of an amine, an aldehyde, and a tannin.

2. A method as recited in claim 1 wherein said amine has primary amine functionality and said aqueous system has a pH of from about 3.5 to about 10.5.

3. A method as recited in claim 1 wherein the modified tannin biofilm control agent is fed to said aqueous system in an amount of about 1 ppm to about 400 ppm.

4. A method as recited in claim 3 wherein said modified tannin biofilm control agent is fed to said aqueous system in an amount of from about 5-200 ppm, said modified tannin biofilm control agent being the Mannich reaction product of tannin, monoethanolamine and formaldehyde.

5. A method as recited in claim 4 wherein said modified tannin biofilm control agent is fed to said aqueous system in an amount of from about 10-100 ppm.

6. The method according to claim 1 wherein the aqueous system is chosen from the group consisting of open recirculating cooling water systems, water transport pipelines, closed cooling systems, reverse osmosis systems, air washer systems, shower water systems, hydrocarbon storage systems, once-through water systems, hydrocarbon transporting pipelines, metalworking fluid systems, and aqueous mineral processing systems.

7. A method as recited in claim 1 wherein said aqueous system is a cooling water system.

8. In an aqueous system of the type in which a scale control agent is present, an improved method comprising adding to said aqueous system a modified tannin biofilm control agent to inhibit biofilm in said system and along surfaces in contact with said system, said modified tannin biofilm control agent being a reaction product of an amine, aldehyde, and tannin.

9. Improved method as recited in claim 8 wherein said scale control agent is an acrylic acid homopolymer, copolymer or terpolymer.

10. Improved method as recited in claim 9 wherein said scale control agent is chosen from the group consisting of an acrylic acid/2-hydroxypropylacrylate copolymer, an acrylic acid/allylhydroxypropylsulfonate ether copolymer, an acrylic acid/2-acrylamide-2-methylpropanesulfonic acid copolymer, or an acrylic acid/polyethyleneglycol monoallyl ether sulfate/1-allyloxy-2-hydroxypropylsulfonic acid terpolymer.

11. Improved method as recited in claim 8 wherein said modified tannin biofilm control agent is a reaction product of an amine having primary amine functionality, aldehyde, and tannin.

12. Improved method as recited in claim 11 wherein said modified tannin biofilm control agent is a Mannich reaction product of monoethanol amine, formaldehyde, and tannin.

13. Improved method as recited in claim 8, wherein said anionic polymeric scale control agent is present in an amount of about 0.1 to about 500 ppm and wherein said modified tannin biofilm control agent is present in an amount of between about 1 ppm to about 400 ppm.

14. A composition for inhibiting microbial film on surfaces, comprising: a biofilm control agent which is the Mannich reaction product of an amine, an aldehyde, and a tannin; and a scale control agent.

15. The composition according to claim 14, wherein the biofilm control agent comprises the Mannich reaction product of a tannin, a monoethanolamine, and formaldehyde, and wherein the scale control agent comprises an acrylic acid homopolymer, copolymer, or terpolymer.
